(19) United States
(12) Patent Application Publication
(10) Pub. No.: US 2015/0161099 A1
(43) Pub. Date: Jun. 11, 2015

(54) METHOD AND APPARATUS FOR PROVIDING INPUT METHOD EDITOR IN ELECTRONIC DEVICE

(71) Applicant: Samsung Electronics Co., Ltd., Suwon-si (KR)

(72) Inventors: Chulmin LEE, Daegu (KR); Haedong LEE, Daegu (KR)

(21) Appl. No.: 14/565,862

(22) Filed: Dec. 10, 2014

(30) Foreign Application Priority Data
Dec. 10, 2013 (KR) 10-2013-0152922

(51) Int. Cl. G06F 17/27; G06F 3/023

(52) U.S. Cl. CPC G06F 17/275; G06F 3/0236

(57) ABSTRACT

A method and a system that detects language information from objects in the electronic device and automatically sets a language for the Input Method Editor (IME) based on the detected language information are provided. The method includes executing an application, recognizing an object in the application, detecting language information related to a language from the object, setting a language for a text IME based on the detected language information, and displaying the text IME for input of the set language. There are various embodiments and modifications from the method and system.

### CROSS-REFERENCE TO RELATED APPLICATION(S)

This application claims the benefit under 35 U.S.C. §119(a) of a Korean patent application filed on Dec. 10, 2013 in the Korean Intellectual Property Office and assigned Serial number 10-2013-0152922, the entire disclosure of which is hereby incorporated by reference.

### TECHNICAL FIELD

The present disclosure relates to Input Method Editors (IMEs). More particularly, the present disclosure relates to a method and apparatus for providing IMEs that allow users to conveniently input text to an electronic device by switching between languages.

### BACKGROUND

With the development of digital technology, various types of electronic devices perform communication and process personal information. Examples of the electronic device are mobile devices, Personal Digital Assistants (PDAs), electronic organizers, smartphones, tablet Personal Computers (PCs), etc. The electronic devices support Input Method Editors (IMEs) or text IMEs that allow users to input (type) text in one or more languages (e.g., Chinese, Korean, Japanese, German, Spanish, etc.)

Electronic devices of the related art support the default language for an IME as a language that the user has recently set to input (type) text. If a user needs to input (type) text in a second language via the IME while inputting text in the default language, the user must switch the default language to the second language and then input text.

In order to switch the default language for IME, systems of the related art require users to directly operate a particular key (e.g., language switching key, etc.) or to directly set and switch a corresponding language for IME.

In order to input text in a language that has been registered in electronic devices but not installed to support IME, users must search for the language, install it and set the options. That is, IME systems of the related art require users to perform additional processes to set a particular language for the IME, which causes users inconvenience. In particular, since text inputting frequently needs to switch between languages for IME in electronic devices, users must search for and select one of the languages registered in the electronic devices, switch to and configure the selected language. This causes users inconvenience.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a system for supporting Input Method Editors (IMEs) that allows users to conveniently and quickly input (type) text to electronic devices by switching between languages for IMEs.

Another aspect of the present disclosure is to provide a method for managing the system.

The electronic devices include at least one of the following: information communication device, multimedia devices, wearable devices and their applications, Application Processor (AP), Graphic Processing Unit (GPU), Central Processing Unit (CPU), etc.

Another aspect of the present disclosure is to provide a system for supporting operations of switching between languages for IME via language recognition in text input mode and effectively inputting (typing) text in the switched language. The present disclosure also provides a method for managing the system.

Another aspect of the present disclosure is to provide a system that implements an optimal environment where text of different languages can be input into electronic devices, and thus enhances use convenience and product competitiveness. The present disclosure also provides a method for managing the system.

In accordance with an aspect of the present disclosure, a method for providing an IME to an electronic device is provided. The method includes executing an application, recognizing an object in the application, detecting language information related to a language from the object, setting a language for a text IME based on the detected language information, and displaying the text IME for input of the set language.

In accordance with another aspect of the present disclosure, an electronic device is provided. The electronic device includes a display unit configured to display an object corresponding to an application that is concurrently executed, a touch panel configured to sense a user's input, and a controller configured to recognize the object, detecting language information of the object, to set a language for a text IME based on the detected language information, and to control the display unit to display the text IME for input of the set language.

In accordance with another aspect of the present disclosure, an electronic device is provided. The electronic device includes a display unit configured to display an object corresponding to an application that is concurrently executed, a touch panel configured to sense a user's input, a storage unit configured to store a program, and a processor configured to execute the program and set a language for a text IME of the electronic device. The program is configured to recognize an object in the concurrently executed application, detect language information from the object, set a language for the text IME based on the detected language information, and displaying the text IME for input of the set language.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an electronic device according to an embodiment of the present disclosure;

FIGS. 2A, 2B, 2C, and 2D illustrate an input method editor (IME) in an electronic device according to an embodiment of the present disclosure;

FIGS. 3A, 3B, and 3C illustrate switching between languages of an IME in an electronic device according to an embodiment of the present disclosure;

FIG. 4 illustrates a flowchart of a method for switching between languages for an IME in an electronic device according to an embodiment of the present disclosure;

FIG. 5 illustrates a method for switching between languages for an IME in an electronic device according to an embodiment of the present disclosure; and

FIG. 6 illustrates a flowchart of a method for switching between languages for an IME in an electronic device according to another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarify and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and elements and do not limit one or more additional functions, operations, and elements. In the present disclosure, the terms such as “include” and/or “have” may be construed to denote a certain characteristic, number, step, operation, element, component or a combination thereof, but may not be construed to exclude the existence of or a possibility of addition of one or more other characteristics, numbers, steps, operations, elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including reference numbers, such as “first” and “second,” etc., and/or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them the first user device and the second user device are user devices. For example, a first element could be termed a second element, and similarly, a second element could be also termed a first element without departing from the scope of the present disclosure. In the case where according to which a component is referred to as being “connected” or “accessed” to other component, it should be understood that not only the component is directly connected or accessed to the other component, but also there may exist another component between them the component and the other component. Meanwhile, in the case where according to which a component is referred to as being “directly connected” or “directly accessed” to other component, it should be understood that there is no component therebetween. The terms used in the present disclosure are only used to describe specific various embodiments, and are not intended to limit the present disclosure. Singular forms are intended to include plural forms unless the context clearly indicates otherwise.

An electronic device according to the present disclosure may be a device including a communication function. For example, the device may be a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., MP3 player), a mobile medical device, a camera, or a wearable device. Examples of a wearable device are a head-mounted-device (HMD) (e.g., electronic eyeglasses), electronic clothing, an electronic bracelet, an electronic necklace, an electronic accessory, an electronic newspaper, a smart watch, etc.

In addition, an electronic device according to the present disclosure may be appliances including a communication function. Examples of home appliances are a television (TV), a Digital Video Disk (DVD) player, an audio system, a refrigerator, an air-conditioner, a cleaning device, an oven, a microwave oven, a washing machine, an air cleaner, a set-top box, a TeleVision (TV) box (e.g., Samsung HomeSync™, Apple TV™, or Google TV™), a game console, an electronic dictionary, an electronic key, a camcorder, an electronic album, or the like.

An electronic device according to the present disclosure may be various medical devices (e.g., Magnetic Resonance Angiography (MRA), Magnetic Resonance Imaging (MRI), Computed Tomography (CT), a scanning machine, an ultrasonic wave device, etc.), a navigation device, a Global Positioning System (GPS) receiver, an Event Data Recorder (EDR), a Flight Data Recorder (FDR), a vehicle infotainment device, an electronic equipment for ships (e.g., navigation equipment, gyrocompass, etc.), avionics, a security device, an industrial or home robot, etc.

An electronic device according to the present disclosure may be furniture or a portion of a building/structure that includes a communication function, an electronic board, an electronic signature receiving device, a projector, various measurement devices (e.g., faucet water, electricity, city gas, electro-magnetic wave), etc., and a combination thereof. It is obvious to those skilled in the art that the electronic device according to the present disclosure is not limited to the aforementioned devices.

Hereinafter, the configuration of the electronic device and the method for controlling the device, according to various embodiments of the present disclosure, will be described in detail as follows referring to the accompanying drawings. It should be understood that the present disclosure is not limited to the following various embodiments.

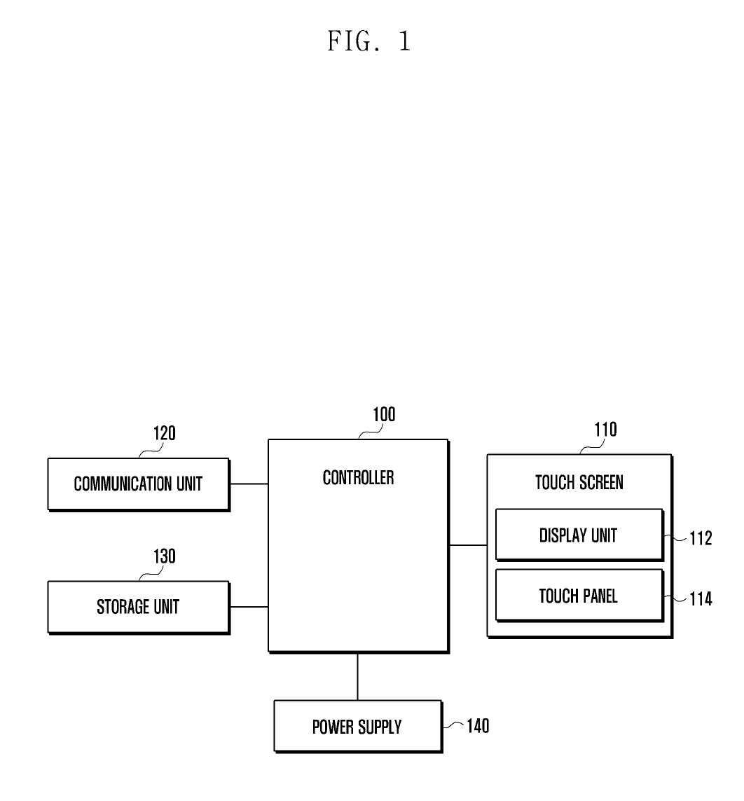

FIG. 1 illustrates a block diagram of an electronic device according to an embodiment of the present disclosure.

Referring to FIG. 1, the electronic device includes a touch screen 110, a display unit 112, a touch panel 114, a communication unit 120, a storage unit 130, a power supply 140, and a controller 100.

It should be understood that, although the configuration of the electronic device according to an embodiment of the present disclosure is schematically shown in FIG. 1, the present disclosure is not limited to the embodiment. That is, the electronic device may be implemented in such a way to include more components than the configuration shown in FIG. 1. It may also be implemented by omitting one or more elements from the configuration shown in FIG. 1 or replacing illustrated elements with other elements. For example, the electronic device according to an embodiment of the present disclosure may further include a sensor for sensing a user's input, a Wireless Local Area Network (WLAN) for supporting wireless Internet, a short-range wireless communication module for supporting short-range distance communication, a broadcast module for receiving broadcasts from external broadcast servers via broadcasting channels (e.g., satellite broadcast channels, terrestrial broadcast channels, etc.), etc. Examples of the sensor are a voice recognition sensor, an infrared sensor, an acceleration sensor, a gyro sensor, a terrestrial magnetism sensor, an illumination sensor, a color sensor, an image sensor, a temperature sensor, a proximity sensor, a motion recognition sensor, etc. Examples of the short-range wireless communication module are Bluetooth™, Bluetooth Low Energy (BLE), Near Field Communication (NFC), Radio Frequency IDentification (RFID), Infrared Data Association (IrDA), etc.

The touch screen 110 performs input and output (display) functions. The touch screen 110 includes a display unit 112 and a touch panel 114. In an embodiment of the present disclosure, the touch screen 110 displays images related to operations of the electronic device on the display unit 112. The touch screen 110 also senses a user's inputs (e.g., touches or hover-based touch events) via the touch panel 114 while a particular image is displaying on the display unit 112. The touch screen 110 senses a user's input and transfers the input signal to the controller 100. The controller 100 identifies the user's input signal and controls the device according to the input signal.

The display unit 112 outputs images based on operations of the controller 100. Examples of the output images include a messenger screen, web pages, a lock screen, a home screen, an application list screen (i.e., a menu screen), a text input screen, a mail writing screen, a Social Networking Service (SNS) screen, etc. The display unit 112 also displays information that the controller 100 processes (e.g., decoding) and stores in a memory (e.g., a frame buffer of the display unit 112).

The display unit 112 displays applications selected according to a user's input under the control of the controller 100. The display unit 112 displays objects (e.g., domains, data, images, text, etc.) of the application according to operations of the controller 100. The display unit 112 displays an Input Method Editor (IME), according to the use of application. In an embodiment of the present disclosure, the IME includes a soft keypad displayed on the display unit 112, an infrared projection keyboard (or laser projection keyboard) projected to an external object that is physically separate from the electronic device (e.g., floor, wall, etc.), etc. In the embodiments of the disclosure, the IME will be described based on a soft keypad. IME may also be referred to as a text IME.

The display unit 112 displays data (e.g., text) that the user inputs via the IME. The display unit 112 displays a language selection window by which the user can select one or more languages. The display unit 112 displays a text IME based on a language that the user selected on the language selection window. Various screens displayed on that the display unit 112 will be described in detail later.

The display unit 110 may be implemented with a Liquid Crystal Display (LCD), a Thin Film Transistor Liquid Crystal Display (TFT LCD), Light Emitting Diodes (LEDs), Organic Light Emitting Diodes (OLEDs), Active Matrix Organic Light Emitting Diodes (AMOLEDs), flexible display, bended display, 3D display, or the like. The displays listed above may be a transparent display, e.g., a transparent type or a translucent type.

The touch panel 114 senses a user's inputs applied to the touch screen 110. Examples of a user's input include operations such a tap, drag, sweep, flick, drag and drop, drawing, single-touch, multi-touch, gesture (e.g., writing), scrolling, flicking, hovering, etc.

The touch panel 114 may convert pressure applied to or change in the capacitance at a particular position on the display unit 112 into an electrical signal. The touch panel 114 senses the position where a touch event occurs and a level of pressure touched according to type of touch panel. The touch panel 114 may be implemented with various types of panels such as a capacitive overlay, a resistive overlay, an infrared beam, etc.

In an embodiment of the present disclosure, the touch panel 114 can sense a user's input gestures, create an analog signal, convert the analog signal into a digital signal, and transfer the digital signal to the controller 100. The signal corresponds to a user's input gesture and may include one or more touch coordinates (x, y).

In an embodiment of the present disclosure, the touch panel 114 can sense the user's inputs during the execution of various applications. The touch panel 114 can also sense the user's inputs related to the execution and use of the IME. The touch panel 114 can also sense the user's input that switches between languages of the IME.

The communication unit 120 performs a voice/video call or data communication with external systems (e.g., a server, other electronic devices, etc.) via a network.

The communication unit 120 includes a Radio Frequency (RF) transmitter for up-converting the frequency of signals to be transmitted and amplifying the signals. The communication unit also includes a RF receiver for low-noise amplifying received RF signals and down-converting the frequency of the received RF signals into data. The communication unit 120 may include a mobile communication module (e.g., a 3rd-Generation (3G) mobile communication module, 3.5G, 4G, etc.), a digital broadcasting module, and a short-range communication module (e.g., a wireless module, Bluetooth™ module, an NFC module, etc.).

The storage unit 130 stores a bootloader, an operating system, and applications. The storage unit 130 stores one or more applications that are executed via the controller 100. The storage unit 130 serves as a buffer for storing data to be input/output, for example, messenger data (e.g., chat data, etc.), contact information (e.g., wired or wireless phone numbers, etc.), messages, contents (e.g., images, videos, audios, etc.), etc. The storage unit 130 stores codes for languages, the corresponding multilingual IMEs, and commands for performing language recognition to support multilingual IMEs. The storage unit 130 stores commands for switching between languages of the text IME.

An application stored in the storage unit 130 may recognize an object in other applications, detect at least one language from the object, configure a language of the text IME based on the detected language, and displaying the text IME with the configured language. In addition, an application stored in the storage unit 130 displays chat lists of the application, senses a user's input for selecting a chat list, determines information of the selected chat list, detects language information from the information, and configures a language of the text IME based on the detected language information. An application stored in the storage unit 130 are may display the application window (e.g., a chat window), and invoke and display the configured text IME according to a user's request for text IME.

The power supply 130 receives electric power from an external or internal power source and supplies the power to components in the electronic device.

The controller 100 controls the operation of the electronic device and the signal flows among the components in the electronic device. For example, the controller 100 performs operations related to a voice/video call, data communication, etc. The controller 100 automatically switches between languages for multilingual text input. The controller 100 may be implemented with one or more processors that execute one or more programs stored in the storage unit 130, configure a language for the IME, and support the multilingual-based text inputting operation by the IME for the configured language.

The controller 100 executes an application corresponding to a user's input and controls the display unit 112 to display the executed application. For example, when a user applies an input to the application, the controller 100 executes the application corresponding to the user's input and controls the display unit 112 to display the application.

The controller 100 recognizes an object of the executed application. Examples of the objects are domain, characters, images, text, etc., on the application window.

The controller 100 detects information related to one or more languages from the recognized object and configures a language of the text IME based on the detected language information to support a text input operation. For example, when the controller 100 detects information related to one or more languages from the recognized object, the controller 100 causes the display unit 112 to display a window selection window so that the user can set the language of the text IME. The language selection window includes an interface (e.g., an interface, with areas separated according to the detected languages, for receives a user's inputs for selecting the corresponding language) that allows the user to select or switch at least one language based on the detected language information. The controller 100 detects a user's input for selecting a language on the language selection window, and switches or configures the current language of the text IME to the selected language.

When the controller 100 detects an operation of switching between languages of a text IME, the controller 100 changes the current language to the selected language. For example, when a language is selected on a language selection window, the controller 100 changes the keyboard layout to the selected language in the text IME and displays it on the display unit 112. Alternatively, the controller my change the current text IME to a text IME mapped to the selected language and displays the text IME for the selected language on the display unit 112.

The controller 100 recognizes language information from an object and transfers the recognized language information to the text IME. The text IME sets up a language or switches types of text IMEs (which are different types of keyboard layouts corresponding to different languages), based on the language information from the controller 100. The controller 100 generates a text IME, which is altered or configured according to the language information, with respect to a user's input for inputting text (or displaying the text IME, switching between text IMEs) via an application, and displays the text IME on the display unit 112.

The controller 100 may also execute a messenger application according to a user's input. In this case, the controller 100 may also display chat lists, which are created when the user had chatted with a particular user (or users in a group), in the messenger application. The controller 100 senses a user's input for selecting a chat item from the chat list. In that case, the controller 100 recognizes information related to a language used in the selected chat. For example, when a chat list is selected, the controller 100 detects user information (e.g., nationality, name, native language, profile picture, etc.) that participated in the chat, detects the language used in the chat, etc., and recognizes language information. When the user participates in the selected chat (e.g., a chat window for the selected chat is displayed), the controller 100 may configure the text IME based on the detected language information. The controller 100 can generate and display the configured text IME so the user can input text in the chat (or to display the text IME).

The controller 100 also controls the functions related to the usual operations of the electronic device. For example, the controller 100 executes applications, controls the operations and the display of corresponding screens. The controller 100 receives input signals corresponding to touch events on a touch-based interface (e.g., touch screen 110) and controls the corresponding operations. The controller 100 also controls data transmission/reception in a wired or a wireless mode.

The embodiments of the present disclosure may be implemented with computer readable media that are be read by computers or the equivalent devices by using software, hardware, or a combination thereof. Hardware may be include Application Specific Integrated Circuits (ASICs), Digital Signal Processors (DSPs), Digital Signal Processing Devices (DSPDs), Programmable Logic Devices (DLDs), Field-Programmable Gate Arrays (FPGAs), processor, controllers, micro-controllers, micro-processors, and electric/electronic units for performing other functions, etc.

The computer readable media includes programs that executes applications, recognizes objects on the applications, detects one or more languages from the objects, configures a text IME on the application in operation to input text in the detected language, and displays the text IME of the configured language.

It should be understood that the embodiments may also be implemented by the controller 100. It should be understood that the processes and functions in the embodiments may also be implemented by one or more software modules, separately. In addition, the one or more software modules may also perform one or more functions or operations described in the present disclosure.

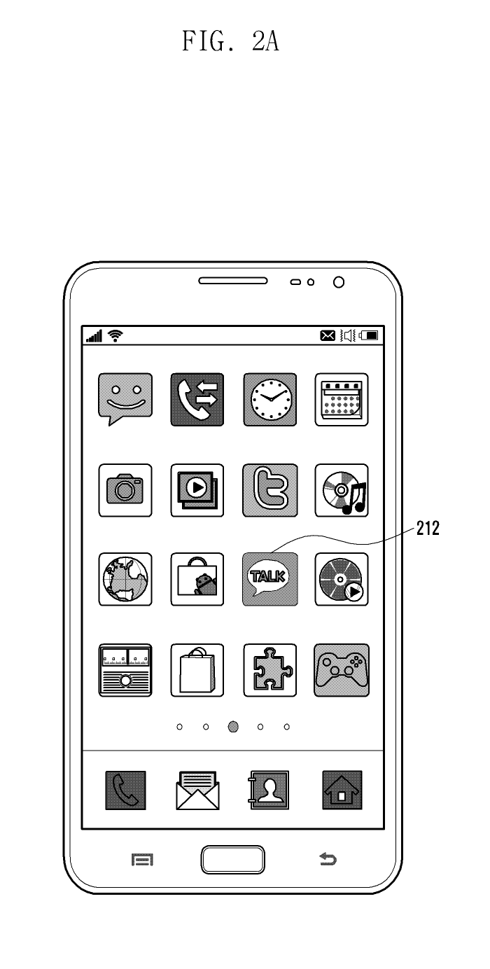

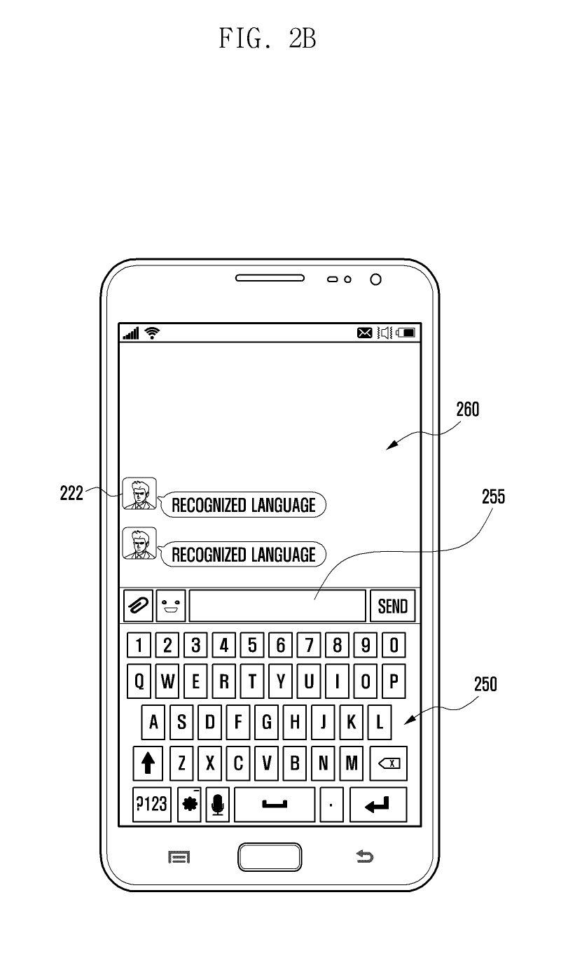

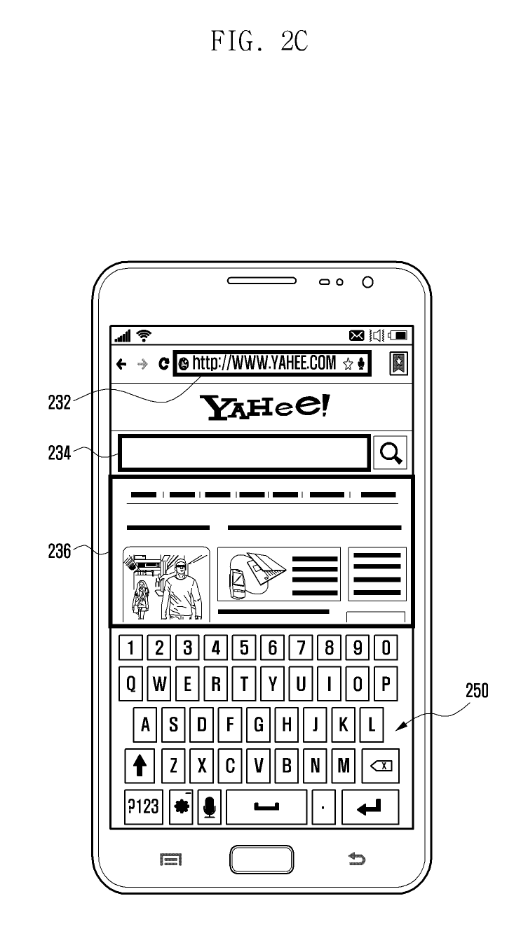

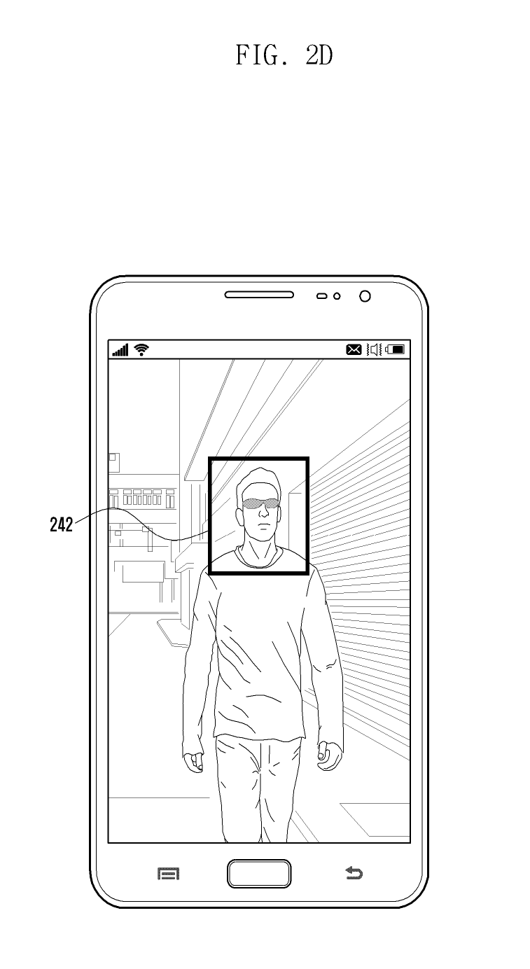

FIGS. 2A, 2B, 2C and 2D illustrate an IME in an electronic device according to an embodiment of the present disclosure.

Referring to FIGS. 2A to 2D, the IME for inputting multilingual text is provided to support user text input into applications such as Internet service (e.g., webpage search, SNS, etc.), messaging, email, access to portal websites, calendar, memo, dictionary, map, gallery, contact, navigation, market, banking, reservation (advance purchase), etc.

FIGS. 2A and 2B illustrate operations for detecting language information of objects in a messenger application and providing an IME of the detected language.

Referring to FIG. 2A, the controller 100 displays a list of applications in response to a user's input. When the user wants to execute an application, the user can select an icon, e.g., an icon of the messenger application 212. An example of selecting the icon 212 is performed by applying a touch.

When the selects the icon 212, the controller executes the corresponding application and displays the executed application (e.g., a chat screen) on the display unit 112 as shown in FIG. 2B.

Referring to FIG. 2B, the controller 100 controls the display unit 112 to display the IME 250 in a portion of the application window (e.g., at the bottom of the screen, at the bottom right in the right-handed input mode, at the bottom left in the left-handed input mode, etc.). For example, after displaying the screen related to the application, the controller 100 receives a user's text input request (e.g., a request for displaying the IME 250) and, in response to the request, displays the IME 250. While displaying the application, the controller 100 can concurrently display the IME 250. The embodiment of the present disclosure as shown in FIG. 2B displays the IME 250 that is set to a default language (e.g., a user's set language, such as Korean, Japanese, etc.).

The controller 100 can sense a user's input for selecting a button allocated with a character on the IME 250 to input text. The controller 100 controls the display unit 112 to display a user's input letters on the character input field 255 of the IME 250. When the user enters letters for chat, the letters are input in the character input field 255 to form a message and, when the user chooses to transmit the composed message (e.g., by touching the SEND button), the controller 100 controls the display unit 112 to display the composed message in the application window (e.g., chat area 260). When displaying a user's composed message in the chat area 260, the controller 100 also controls the communication unit 120 to transmit data related to the composed message to the receiving users' devices (a group of users) that have participated in the chat.

When the user's electronic device previously communicated with a receiving user's device (or devices of users in the group, which are called other users) via a messenger application, as shown in FIG. 2B, the controller 100 can receive data of objects (letters) that other users input to their electronic devices via the communication unit 120. When the controller 100 receives data from the other electronic devices, the controller 100 can control the display unit 112 to display objects (e.g., message, multimedia, letters, etc.) corresponding to the received data in the application (e.g., chat area 260).

The user's device may receive from the other users' electronic devices in a different language. For example, each user languages may be different. That is, users in the chat may use each other different languages, as native languages, e.g., English, Chinese, Japanese, German, Spanish, etc. Some users may set the language of their electronic devices to a specific language regardless of their native languages. Therefore, during the chat, data transmitted between users' electronic devices may be displayed in various languages, such as, English, Chinese, Japanese, German, Spanish, etc.

In an embodiment of the present disclosure, the controller 100 can perform a language recognition function in a text input mode via the IME 250. The language recognition function can be executed when an application is executed, when the IME is executed when an event (e.g., data reception, a user's language recognition request) is detected during the execution of application, and so forth. When the controller 100 performs language recognition and detects language information that differs from the default language of the IME 250, the controller 100 switches the language of the IME 250 to the detected language.

For example, the controller 100 receives data from the other user's electronic device, displays objects (i.e., letters) corresponding to the received data on the display unit 112, and performs language recognition for the objects. The controller 100 detects language information from the objects via language recognition. When the controller 100 ascertains that the detected language of the other user's electronic device differs from the user's set language set of the IME 250, language can switch the language of the IME 250 to the detected language.

The switching of languages for the IME 250 may be performed in an automatic mode or by a user's direct operation. For example, if the detected language information includes one language, the controller 100 refers to a user's settings (e.g., automatic switching mode) and may automatically alter the language of the IME 250 based on the detected language. If the detected language information includes is multilingual or if the detected language information includes a single language and direct switching mode, the controller 100 displays a language selection window for selecting a language to be set in the IME 250.

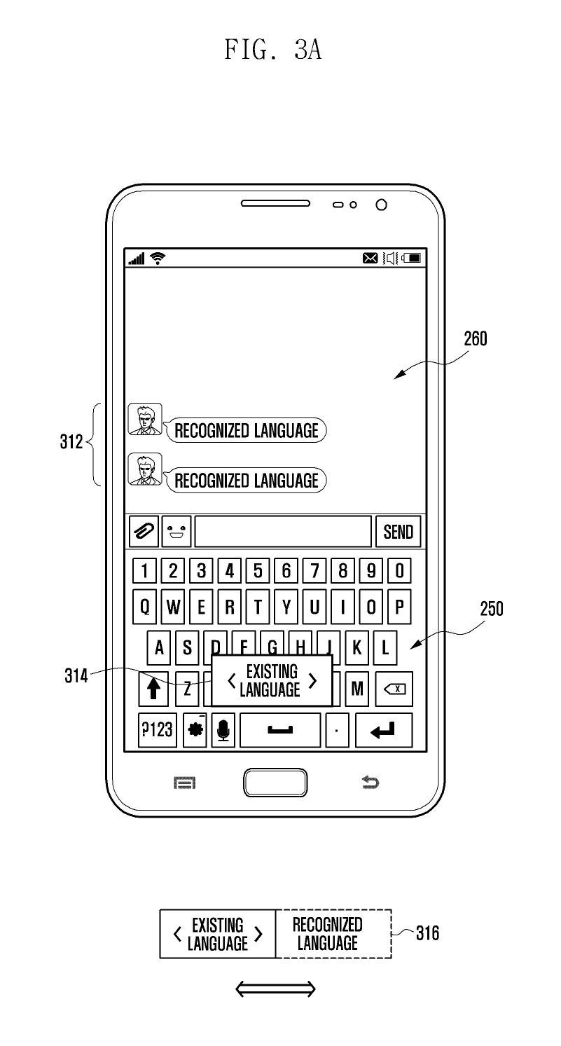

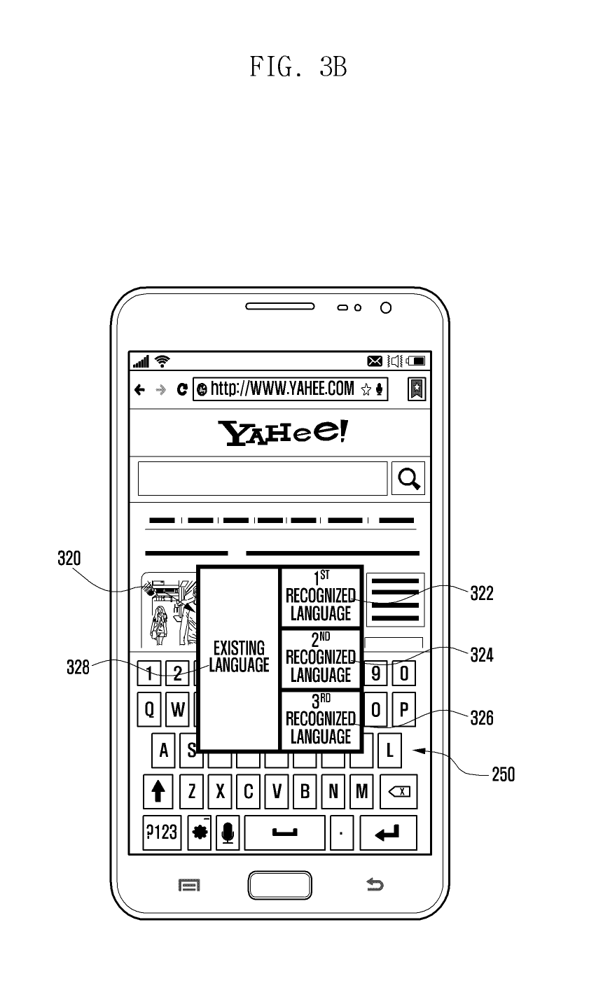

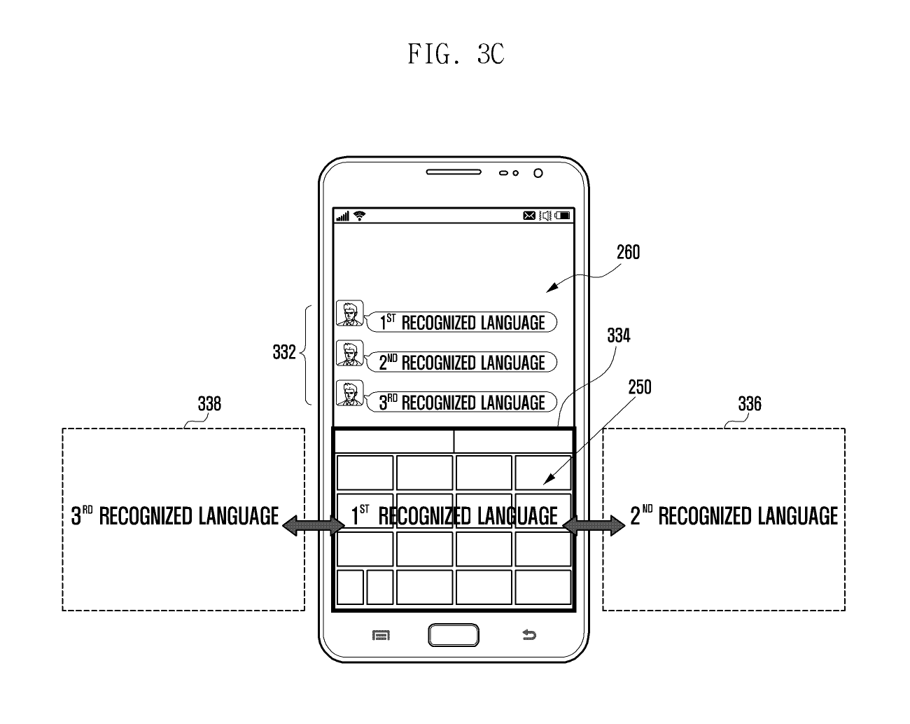

When the controller 100 senses a user's input for selecting a language on the language selection window, the controller switches or sets the current language of the IME 250 to the selected language. The operation of switching between languages of the IME 250 is described in detail below with reference to FIGS. 3A to 3C.

Referring to FIG. 2C, the operations for detecting language information from objects of an Internet application and providing an IME of the detected language are illustrated.

When the user selects an icon of an Internet application on the list shown in FIG. 2A, the controller 100 detects a user's input for the selection. The controller 100 executes the selected application and displays the corresponding screen (e.g., a web page) in the application as shown in FIG. 2C.

The controller 100 senses a user's inputs to the web page. For example, when the user requests a text input for searching for a web page (e.g., selecting a search bar 234 and ten requesting the display of the IME 250), the controller 100 can sense the user's request. The controller 100 sets a text input mode in response to the user's text inputting operation. To this end, the controller 100 can perform language recognition on objects included in the web page. For example, the objects may include a domain name, an Internet Protocol (IP) address, an input to the address field 232, images, data displayed on a data area 236 (e.g., letters, tag, Uniform Resource Locator (URL), coded labels readable in the electronic device, such bar codes, etc.), and so forth.

In an embodiment of the present disclosure, the controller 100 recognizes objects in the web page and detects languages information. For example, domain names provided by web pages are hierarchically organized such as the top-level domain, the sub-domain, host name, etc. The top-level domain represents the country code. The controller 100 can recognize country information from the domain and detect the language information from the recognized country information.

Uniform Resource Locators (URLs) of web pages are addresses of information, resources, etc. on the Internet, i.e., as servers, computers, etc. When the controller 100 detects a URL from a web page, the controller 100 can recognize location information where the web page, etc. is provided and can detect language information based on the recognized location (or area).

Since web pages are provided in one or more languages (English, Chinese, Japanese, Korean, German, Spanish, etc.), the controller 100 can recognize country information from letters of the web pages and detect the language information from the recognized country information.

The controller 100 detects languages via objects recognized from the web page and sets a language for the IME 250 based on the detected language information. For example, if the IME 250 is set to automatically set the language and only one language is detected, the controller 100 automatically switches the current language of the IME 250 to the detected language. If the IME 250 is set to automatically set the language and more than one language is detected, the controller 100 automatically switches the current language of the IME 250 to the language having the highest priority (e.g., with respect to the highest level of condition set by the user, such as letter condition, condition, etc.). The controller 100 can also control the display unit 112 to display a language selection window on which the user selects one of the detected languages (or sets a language of the IME 250). The language selection window is designed in such a way to select one or more languages for the IME 250 based on the detected language information. The operations of the language selection window will be described in detail later.

FIG. 2D illustrates operations for detecting language information from objects (e.g., images) of a gallery application and providing an IME of the detected language.

When the user selects to execute a gallery application, the controller 100 executes the gallery application and controls the display unit 112 to display the corresponding screen (e.g., a user's selected image screen) on the application window as shown in FIG. 2D.

In an embodiment of the present disclosure, images stored in the electronic device may include various types of objects (e.g., automatically or manually created information). For example, when the user takes a picture of a subject (e.g., a person, scenery, an animal, etc.) using a photographing function of the electronic device, the electronic device can store one or more objects with the picture in automatic or manual mode. That is, the user can store the picture in the electronic device and, according to the subject (e.g., a person, scenery, an animal, etc.), can store objects such as age, relationship, nationality, contact, location where the picture has been taken, etc. When taking a picture of a subject, the electronic device can automatically create objects for the picture such as weather, geographical location information, etc., and store the objects with the picture (e.g., as metadata, etc.). The electronic device according to the embodiment of the present disclosure can also store images acquired from other sources such web pages or SNS that include one or more objects obtained from the source.

The electronic device support a reply function that allows, after viewing images from an application (e.g., a gallery application, an Internet browser, etc.), may allow the user to transmit messages (e.g., comments, writing, SMS, MMS, etc.) to a user related to the persons of the images or to a user whom posted the images via a web page or SNS.

When the electronic device user needs to the message transmission function by using the image displayed on the display unit 112, the user can operate the electronic device to input text for messages. The controller 100 sets a text input mode in response to the user's operation for inputting text. To this end, the controller 100 recognizes the image or objects (e.g., information) related to the image.

In an embodiment of the present disclosure, the controller 100 recognizes objects of the image and detects language information. For example, the controller 100 recognizes country information from the contact, geographical location information, and country information from the objects of the image, and detects language information corresponding to the recognized country information.

In an embodiment of the present disclosure, as shown in FIG. 2D, the controller 100 can perform face recognition an image that extracts a face image 242. The controller 100 compares the extracted face image 242 with contact or memo, etc., stored in the storage unit 130, ascertain objects corresponding to the face image 242, and detect language information from the ascertained objects.

The controller 100 detects languages information via objects recognized from the image and sets a language of the IME 250 based on the detected language information. For example, if the IME 250 is set in an automatically language setting mode and the number of detected languages is one, the controller 100 automatically switches the current language of the IME 250 to the detected language. If the IME 250 is set in an automatically language setting mode and detected language information is more than one, the controller 100 automatically switches the language of the IME 250 to the highest priority language (e.g., with respect to the highest level of condition set by the user, such as user's set country, contact, geographical location information, etc.). The controller 100 can also control the display unit 112 to display a language selection window that the user selects one of the detected languages (or sets a language of the IME 250).

When the electronic device user needs to transmit a message to a corresponding user by using an image, the user inputs text for the message in a language that the corresponding user of the image is using, thereby rapidly transmitting it to the corresponding user. The operations of the language selection window for setting a language of the IME 250 will be described in detail later.

FIGS. 3A, 3B, and 3C illustrate switching between languages of the IME 250 in an electronic device according to an embodiment of the present disclosure.

Referring to FIGS. 3A, 3B, and 3C, the language selection window for switching between languages of the IME 250 can be provided in various modes. The language selection window may include an interface for selecting or switching a language from the detected language information. For example, the interface may be implemented such that a number of separated areas from the detected language information and receives a user's input for selecting a language.

Referring to FIG. 3A, the controller 100 receives objects 312 (e.g., letters transmitted from the other chat user) while the messenger application is executed in the electronic device as shown in FIG. 2B. The received objects 312 may be text in any languages.

The controller 100 detects language information from the received object 312 while the messenger application is executed. In an embodiment of the present disclosure, the chat user transmitting the object 312 represents one or more chat users who use languages that are different from the user's language. The chat users may use various languages, e.g., English, Chinese, Japanese, Spanish, German, or the like. The chat users may also set any languages that they want to speak in to their electronic devices, regardless of their native languages. Therefore, objects transmitted between the electronic devices may be formed in different languages (e.g., English, Chinese, Japanese, Spanish, German, or the like) and displayed in the original language. The controller 100 analyzes the received object and detects language information.

After detecting language information from the object 312, the controller 100 displays a language selection window 314. In an embodiment of the present disclosure, the language selection window 314 may be displayed on part of the area displaying the IME 250 or on part of the chat area 260. The language selection window 314 allows the user to select or set one or more languages corresponding to the detected language information.

FIG. 3A shows an example where the language that the user of the electronic device is using (e.g., an existing language set to the IME 250 of the electronic device) differs from the language corresponding to the detected language information that the other chat user is using. The language selection window 314 provides an interface for switching between the existing language and a recognized language 316. In an embodiment of the present disclosure, the electronic device may set a language of the IME 250 by switching between the existing language and the recognized language 316 as the user selects a graphical element the language selection window 314 or performs a dragging, a flicking, or the like, on the window 314.

In an embodiment of the present disclosure, the electronic device may set a language of the IME 250 by switching between languages displayed on the language selection window 314 as the user applies a first position changing motion to the electronic device (e.g., the electronic device is tilted to the left or right with respect to the vertical axis of the lengthwise center) to the electronic device or a second position changing motion (e.g., a stopping motion is applied to the electronic device or a second position defined from the first posture is applied to the electronic device). It should be understood that the language selection window 314 is not limited to the embodiment of the present disclosure shown in FIG. 3A and there are many modifications therefrom. For example, although the language selection window 314 is implemented in the left-right slide type as shown in FIG. 3A, the language selection window 314 may also be implemented in the up-down side type, a circular type, etc.

Although it is not shown in FIG. 3A, the controller 100 determines whether to recognize an object when the IME 250 is displayed. When the language information detected from the recognized object differs from the current language of the IME 250, the controller 100 displays the language selection window 314. The controller 100 also determines whether to recognize an object when the IME 250 is not displayed. When the language information detected from the recognized object differs from the current language of the IME 250, the controller 100 automatically switches the language of the IME 250 to the detected language, and displays the IME 250 of the switched language when it is requested to be displayed. In addition, when the controller 100 recognizes an object when the IME 250 is not displayed and when the detected language information from the recognized object differs from the current language of the IME 250, the controller 100 may also display the language selection window 314 with the IME 250 together.

Referring to FIG. 3B, the controller 100 sets the text input mode in response to the user's input when web pages are displayed during the execution of a web browser application.

When setting the text input mode, the controller 100 detects language information from the objects of the web page. The objects of the web page may include a domain name (or IP address), images, data of the webpage (e.g., letters, tag, labels, URL, etc.), and metadata of the webpage. The controller 100 analyzes language information from the objects included in the web page and detects a corresponding language.

After detecting language information, the controller 100 displays a language selection window 320 in part of the area where the IME 250 is displayed or on part of the area where the web page is displayed. The language selection window 320 includes an interface for selecting or switching to the detected language information.

FIG. 3B shows an example where the user's language (e.g., an existing language set to the IME 250 of the electronic device) differs from the detected language information. The language selection window 320 provides an interface for selecting an existing language and languages in the detected language information. For example, the interface may be implemented with separated areas corresponding to the existing language 328, a first recognized language 322, a second recognized language 324, and a third recognized language 326.

The existing language 328 and the first, second, and third recognized language 322, 324 and 326 may be arranged in order of priority (e.g., letters, domain names, etc.) on the language selection window 320. In an embodiment of the present disclosure, when the controller 100 recognizes objects in a web page and detects language information, the controller 100 may also determine the priority order of the languages for arrangement on the language selection window 320 based on the distribution, use frequency, etc. of the different languages. In an embodiment of the present disclosure shown in FIG. 3B, the controller 100 recognized the existing language 328 as the highest order of priority, following in order by the first, second, and third recognized languages 322, 324 and 326.

The embodiment of the present disclosure may be implemented in such that the existing langue 328 of the IME 250 is set as a default language regardless of the order of priority and the first, second, and third recognized languages 322, 324, and 326 are arranged in order of priority. For example, referring to FIG. 3B, the embodiment of the present disclosure shows the three recognized languages in such a way that the 1st recognized language 322 is set as the 1st order of priority and the 2nd and 3rd recognized languages are set as the 2nd and 3rd priority, respectively.

The controller 100 may provide the language selection window 320 with or without the existing langue 328. The existing langue 328 may a language that the user has most recently used (e.g., the current language set to the IME 250).

It should be understood that the language selection window 320 is not limited to the embodiment of the present disclosure shown in FIG. 3B but there are many modifications therefrom. That is, although the language selection window 320 has four separated areas as shown in FIG. 3B, it may be implemented to have separated areas more than five or according to the number of detected languages and may also be displayed in various shapes.

Referring to FIG. 3C, the language selection window 320 may be implemented as a translucent layer of the feature size corresponding to the IME 250 (e.g., the same width and length as the IME 250).

If the messenger application is executed, the controller 100 detects language information from the recognized objects 332. When the controller 100 detects language information from the objects 332, the controller displays a language selection window on part of the display unit 112. The controller 100 may display a language selection window as a translucent layer that is displayed over the IME 250.

If a user is using an IME 250 of a language (e.g., Korean, etc.), the electronic device may receive objects 332 in other languages (e.g., Chinese, Japanese, and German, etc.). In that case, the controller 100 detects language information from the objects 332 and recognizes languages (e.g., Chinese, Japanese, and German, etc.). The controller 100 configures IMEs corresponding to the languages based on the detected language information in layers 334, 336, and 338, respectively. In that case, the controller 100 displays the layer 334 corresponding to the IME of the highest priority language in the translucent form on the current IME 250 and allows the user select different layers (e.g., layer 336, layer 338, etc.). The embodiment of the present disclosure shown in FIG. 3C is implemented in such a way that the first recognized language for the objects 332 is the highest order of priority.

The controller 100 displays an IME 334 of the first recognized language on the area of the IME 250 of the display unit 112, where the IME 334 is in the a translucent layer having a size of the IME 250. Although the controller 100 doesn't display IMEs 336 and 338 corresponding to second and third recognized languages respectively, it creates them when creating the IME 334 of the first recognized language. Therefore, the controller 100 controls the IMEs 336 and 338 in the electronic device. When the controller 100 detects a user's input (e.g., dragging, flicking, scrolling, etc.) on the translucent layer corresponding to the IME of the first recognized language on the IME 250, the controller switches display to the second recognized language on layer 336 or third recognized language on layer 338. The controller 100 receives a user's input for switching between IMEs, switches the current IME to the requested IME, and displays it. After that, the controller 100 sets the currently displayed IME as a default IME, according to a user's input for setting an IME. Therefore, the electronic device user can input text via the IME 250 in the selected language.

Although the embodiment of the present disclosure shown in FIG. 3A or 3C is implemented in such a way that the controller 100 detects language information from all the received objects and provides a corresponding langue selection window, it may be modified in such a way that the controller 100 detects language information from the last received object and automatically switch the current language of the IME 250 to the language corresponding to the detected language information. For example, when the electronic device receives an object from the other electronic device while it executes the messenger application, the controller 100 detects language information from the received object and automatically switches the current language of the displayed IME 250 to the detected language.

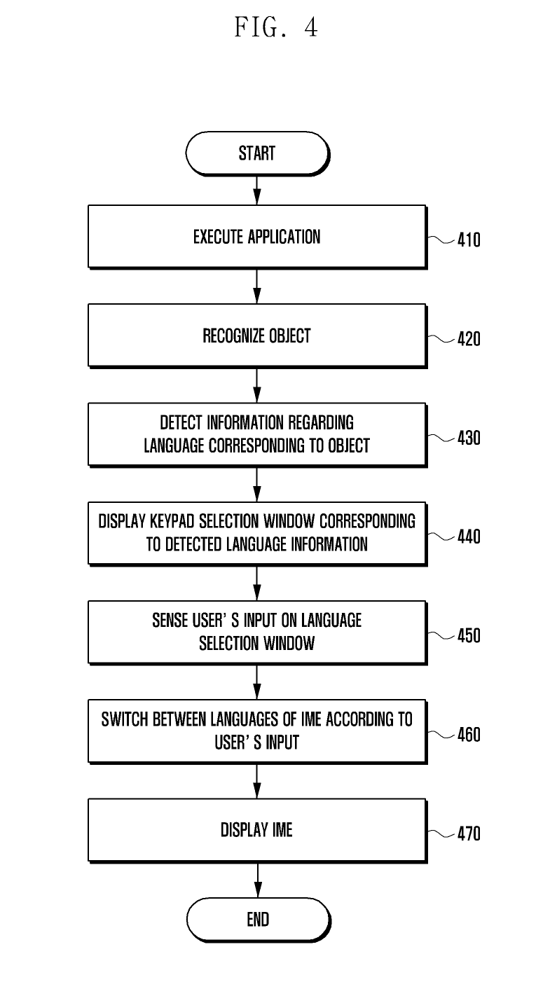

FIG. 4 illustrates a flowchart of a method for switching between languages of IME in an electronic device according to an embodiment of the present disclosure.

Referring to FIG. 4, the controller 100 executes an application in response to a user's input at operation 410. For example, when the electronic device is in idle mode, the controller 100 detects input for executing an application via the touch panel 114. In that case, the controller 100 executes the corresponding application and controls the display unit 112 to display the application.

The controller 100 recognizes one or more objects of the application at operation 420. The objects may include domain names, data, images, text, etc. of the application.

The controller 100 detects language information from the recognized objects at operation 430. For example, if the controller 100 recognizes text on the application, the controller 100 can detect language information from the recognized text using a language recognition algorithm. If the controller 100 recognizes a domain name on the application window, it can detect language information from the recognized domain name by using the country code (e.g., KR for South Korea, US for the United States, CN for China, CA for Canada, FR for France, JP for Japan, etc.) or the IP address. If the controller 100 recognizes an image on the application window, the controller 100 can detect language information from the recognized image by recognizing the background or human face in the recognized image.

The controller 100 controls the display unit 112 to display the detected language information on the language selection window at operation 440. For example, if the detected language information includes a language of a particular country, the controller 100 provides a language selection window for selecting one IME for supporting the corresponding language. If the detected language information includes multiple languages, the controller 100 provides a language selection window for selecting one of the IMEs for supporting the detected languages. The controller 100 can display the detected language information on the language selection window in an order of priority.

The controller 100 senses a user's input on the language selection window at operation 450.

The controller 100 switches the current IME to the language selected according to the user's input, or alters and sets the language of the IME to a language selected according to the user's input, at operation 460.

The controller 100 controls the display unit 112 to display the switched IME at operation 470. When the user selects a particular language on the language selection window, the controller 100 switches the existing IME (i.e., the IME that has been set as a default IME or the language of the IME) to the selected IME (or selected language), and controls the display unit to display the switched IME. When displaying the switched IME, the controller 100 may remove the language selection window from the display unit.

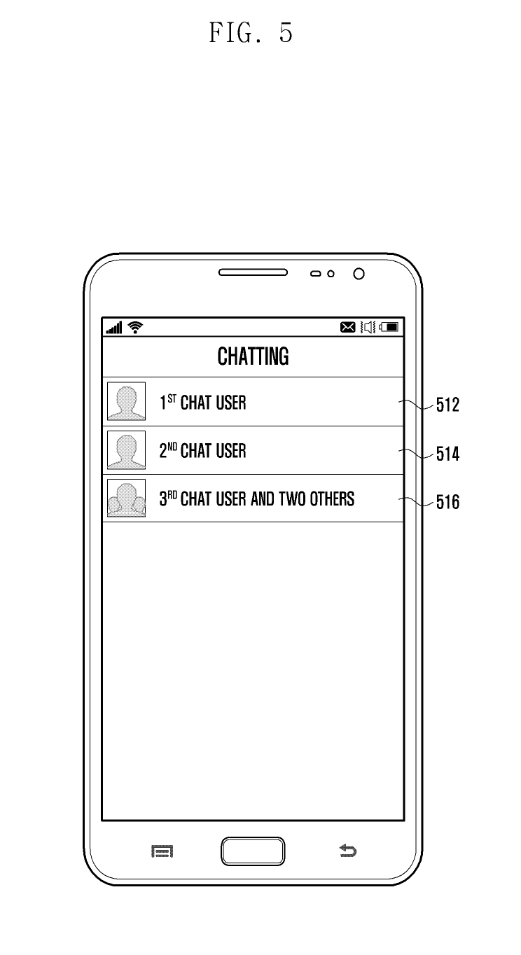

FIG. 5 illustrates a method for switching between languages of IME in an electronic device according to an embodiment of the present disclosure.

Referring to FIG. 5, when the user views a chat list of a messenger application or to chat with a particular group via a messenger application, the controller 100 controls the display unit 112 to display the messenger application. For example, the controller 100 displays chat lists, such as a first chat item (e.g., first chat user 512), a second chat item (e.g., second chat user 514) and a third chat item (e.g., third chat user and two others 516), on the application window as shown in FIG. 5. Each of the first, second, and third chat items includes the details of the chat users, such as, phone numbers, addresses, names, ages, nationalities, etc. The details of users may be stored in the format of address or memo in the storage unit 130.

The user of the electronic device may select one chat item from the chat lists to perform communication with the recipients of the chat users (e.g., first chat user 512). If the first chat user 512 speaks Chinese, the user must switch the current language of the IME (e.g., the language that the user has recently used) to Chinese to chat with the 1st chat user 512.

In an embodiment of the present disclosure, when the controller 100 senses a user's input for selecting the first chat user 512, the controller 100 detects details related to the 1st chat user 512 in the storage unit 130. The controller 100 detects the language information from the detected details of the first chat user 512. The controller 100 switches the current language of the IME to the detected language information of the first chat user 512. Switching between languages of the IME may be performed by all the processes that have been described above in the embodiments of the present disclosure. After that, the controller 100 controls the display unit 112 to display the chat window for chatting with a corresponding chat list (e.g., a first chat user 512) corresponding to the user's input.

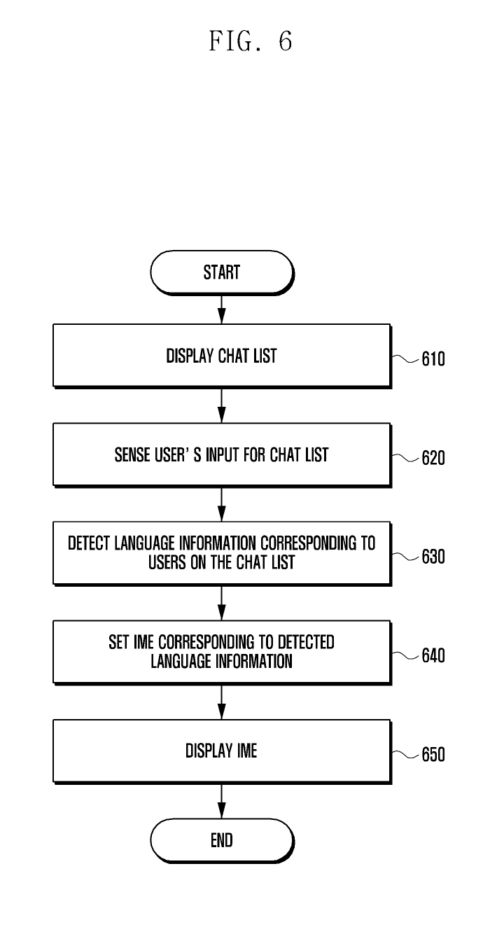

FIG. 6 illustrates a flowchart of a method for switching between languages of an IME in an electronic device according to another embodiment of the present disclosure.

Referring to FIG. 6, the controller 100 controls the display unit 112 to display a chat list of an application in response to a user's request at operation 610.

The controller 100 senses a user's input for selecting one of the chat items in the chat list at operation 620.

The controller 100 detects language information of a chat user associated with the chat item at operation 630.

The controller 100 configures the IME corresponding to the detected language information at operation 640. For example, the controller 100 detects language information from the details of the selected chat item in response to the user's IME, and sets the language of the IME based on the detected language information.

The controller 100 controls the display unit 112 to display the configured IME at operation 650. For example, the controller 100 can display the altered IME when the chat window for the selected chat list is displayed. After displaying the chat window, the controller 100 can invoke and display the altered IME in response to a user's input for requesting an IME.

In an embodiment of the present disclosure, the IME includes a soft keypad IME that is based on a touch input method and displayed the IME on a suitable input mechanism such as, for example, the display unit 112, an infrared projection keyboard (or laser projection keyboard), etc. When the electronic device according to an embodiment of the present disclosure is implemented with an infrared projection keyboard (or laser projection keyboard), the electronic device can detect language information from objects received from other electronic devices and alter the language of the infrared projection keyboard (or laser projection keyboard) based on the detected language information. For example, an infrared projection keyboard layout for the IME can be switched from a user's native language (e.g., Korean) to a language corresponding to the detected language information (e.g., English, Chinese, Japanese, German, etc.).

As described above, the present disclosure can support the multilingual IME that allows users to efficiently input text in corresponding languages to electronic devices. The present disclosure can support the multilingual IME that allows users to easily input text in corresponding languages to electronic devices by switching between languages.

The present disclosure can automatically recognize, when text needs to be input to electronic devices in text input mode by switching between languages, a corresponding language to be switched, so that the electronic devices automatically switch a current language to the recognized language, i.e., the corresponding language for IME and users conveniently and easily input text in the language. When text needs to be input to electronic devices by switching between languages for IME, the present disclosure can automatically switch and configure the language, thereby reducing language switch and set up time and also removing use inconvenience, such as user's operations for setting up IME options to switch between languages.

The present disclosure achieve an optimal environment in electronic devices to support the efficient text input according to different input languages, thereby enhancing use convenience, access, product competitiveness.

The various embodiments of the present disclosure can be modified in such a way that the modules may be implemented in software, firmware, hardware or a combination thereof. The various embodiments of the present disclosure can be modified in such a way that part or all of the modules may be integrated into one entity, so that they are performing their own functions respectively. The various embodiments of the present disclosure can be modified in such a way that the operations can be performed sequentially, repeatedly, or parallel. The various embodiments of the present disclosure can be modified in such a way that part of the operations can be removed or replaced with corresponding operations.

As described above, the various embodiments of the present disclosure can be implemented with program commands that can be conducted via various types of computers and recorded in a non-transitory computer-readable recording media. The non-transitory computer-readable recording media contain program commands, data files, data structures, or the like, or a combination thereof. The program commands recorded in the recording media may be designed or configured to comply with the disclosure or may be software well-known to the ordinary person skilled in the art.

The non-transitory computer-readable recoding media include magnetic media such as a hard disk, a floppy disk, a magnetic tape, etc.; optical media such as Compact Disc-Read Only Memory (CD-ROM), DVD, etc.; Magneto-Optical Media such as a floptical disk, etc. The hardware systems for storing and conducting program commands include Read-Only Memory (ROM), Random Access Memory (RAM), flash memory, etc. The program commands include assembly language or machine code complied by a complier and a higher level language interpreted by an interpreter. The hardware systems may be implemented with at least one software module to comply with the disclosure. The software systems may also be implemented alone or in combination with at least one hardware module to comply with the disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing an input method editor (IME) to an electronic device, the method comprising:
executing an application;
recognizing an object in the application;
detecting language information related to a language from the object;
setting a language for a text IME based on the detected language information; and
displaying the text IME for input of the set language.

2. The method of claim 1, wherein the displaying of the text IME comprises:
sensing a user's input for requesting to display the text IME; and
invoking the text IME for the set language in response to the user's input.

3. The method of claim 2, wherein the setting of the language for the text IME comprises:
displaying a language selection window corresponding to the detected language information, wherein the language selection window comprises:
an interface for selecting a language corresponding to the detected language information.

4. The method of claim 3, wherein the language selection window comprises:
providing a text IME corresponding to the detected language information as a translucent layer disposed over the application.

5. The method of claim 2, wherein the setting of the language for a text IME comprises:
determining, when the detected language information includes a number of languages, an order of priority of the languages; and
setting the text IME based on the highest order of language from the detected language information.

6. The method of claim 1, wherein the detecting of the language information comprises:
determining whether the language corresponding to the detected language information is the same as a language for the current text IME.

7. The method of claim 6, wherein the displaying of the text IME comprises:
switching, when the language corresponding to the detected language information differs from a language for the current text IME, the current text IME to a text IME for the language corresponding to the detected language information.

8. The method of claim 3, wherein the displaying of the language selection window comprises:
selecting a language on the language selection window; and
replacing the current text IME with a text IME for the selected language; and
displaying the text IME.

9. The method of claim 1, further comprising:
displaying a chat list of the application;
sensing a user's input for selecting the chat list;
determining chat list information corresponding to the user's input;
detecting language information from the chat list information; and
setting a language for the text IME based on the detected language information.

10. The method of claim 1, wherein the text IME comprises:
a soft keypad displayed on a display unit of the electronic device;
an infrared projection keyboard projected on a foreign surface.

11. An electronic device comprising:
a display unit configured to display an object corresponding to an application that is concurrently executed;
a touch panel configured to sense a user's input; and
a controller configured to recognize the object, to detect language information related to a language of the object, to set a language for a text Input Method Editor (IME) based on the detected language information, and to control the display unit to display the text IME for input of the set language.

12. The electronic device of claim 11, wherein the controller displays the text IME for the set language in response to a user's input for displaying the text IME.

13. The electronic device of claim 11, wherein:
the controller displays a language selection window corresponding to the detected language information; and
the language selection window comprises an interface for selecting a language corresponding to the detected language information.

14. The electronic device of claim 13, wherein the language selection window provides at a text IME corresponding to the detected language information as a translucent layer disposed over the application.

15. The electronic device of claim 11, wherein the controller determines, when the detected language information includes a number of languages, an order of priority of the languages; and sets the text IME based on the highest order of language from the detected language information.

16. The electronic device of claim 11, wherein the object comprises at least one of a domain name, an image, data, and text.

17. The electronic device of claim 11, wherein the controller determines whether the language corresponding to the detected language information is the same as a language for the current text IME and switches, when the language corresponding to the detected language information differs from a language for the current text IME, the current text IME to a text IME for the language corresponding to the detected language information.

18. The electronic device of claim 13, wherein the controller replaces, in response to a user's input for selecting a language on the language selection window, the current text IME to the selected language and displays the text IME.

19. The electronic device of claim 11, wherein the controller displays a chat list of the application, detects, in response to a user's input for selecting chat information, language information from the chat list information; and sets a language for the text IME based on the detected language information.

20. An electronic device comprising:
a display unit configured to display an object corresponding to an application that is concurrently executed;
a touch panel configured to sense a user's input;
a storage unit configured to store a program; and
a processor configured to execute the program and set a language for a text Input Method Editor (IME) of the electronic device,
wherein the program configured to:
recognize the object in the concurrently executed application;
detect language information from the object;
set a language for the text IME based on the detected language information; and
display the text IME for input of the set language.
